(19) United States
(12) Patent Application Publication
(10) Pub. No.: US 2020/0104761 A1
(43) Pub. Date: Apr. 2, 2020

(54) PAYMENT CARD FOR MULTI-LEG JOURNEY

(71) Applicant: Ford Global Technologies, LLC, Dearborn, MI (US)

(72) Inventors: Sudipto Aich, Palo Alto, CA (US); Jeanne Isaacs, Los Altos, CA (US); Will Farrely, San Francisco, CA (US); Vinita Isranti, Palo Alto, CA (US)

(73) Assignee: Ford Global Technologies, LLC, Dearborn, MI (US)

(21) Appl. No.: 16/585,241

(22) Filed: Sep. 27, 2019

Related U.S. Application Data
(60) Provisional application No. 62/738,298, filed on Sep. 28, 2018.

(51) Int. Cl. G06Q 10/02; G06Q 20/32; G06Q 20/34; G06Q 50/30

(52) U.S. Cl. CPC G06Q 10/02; G06Q 50/30; G06Q 20/357; G06Q 20/3224

(57) ABSTRACT

Embodiments of the disclosure allow a universal access card, computing device, and/or application operating on a computing device to provide access and pay for multiple modes of transportation in a multi-segment journey. The universal access device may be provided by a centralized transportation management service, and may be used in conjunction with a mobile application on a computing device, to reserve a seat, plan a multi-segment journey across various modes of transportation and/or various transportation providers. When a user initiates a segment of the multi-segment journey by embarking on the first transportation provider, the universal access device provides access to the first transportation provider and may automatically provide payment to the first transportation provider. In monitoring the geo-location of the user, the universal access device can initiate access and payment to a second transportation provider when the user is ready to embark on a second segment of the multi-segment journey.

### RELATED APPLICATION

The present application claims priority to U.S. Provisional Patent Application No. 62/738,298, filed Sep. 28, 2018, and entitled “PAYMENT CARD FOR MULTI-LEG JOURNEY,” which is hereby incorporated by reference in its entirety as if fully set forth herein.

### FIELD OF THE DISCLOSURE

This disclosure generally relates to transportation services, and more particularly relates to systems and methods that assist a customer for traveling from one location to another using various types of transportation.

### BACKGROUND

People are increasingly turning to a variety of different transportation and mobility offerings, including ridesharing, carpooling, shuttle services and e-biking in addition to conventional public transit offerings such as trains and public buses. However, it can be overwhelming for a user to select between these numerous transportation options and to pay for them. Since many transportation options are not universally operated on the same platform, many users often have multiple applications on their mobile devices and/or multiple transportation fobs or cards to access and pay for the different transportation modes taken. For example, a user may request a route from point A to point B with various segments of the route taken by different forms of transportation, such as by bus, train, subway, rideshare, taxi, scooter, bikeshare, or other transportation platform. To complete the route with various segments involving multiple modes of transportation can be cumbersome for the user because each mode may require a different mobile application and payment process. It therefore may be desirable to implement a universal platform to centralize access and payment of multiple transportation modes and segments to maximize utilization of and accessibility to all modes of transportation and provide transportation mobility to users.

### BRIEF DESCRIPTION OF THE DRAWINGS

Various embodiments in accordance with the present disclosure will be described with reference to the drawings, in which:

FIGS. 1A and 1B illustrate an example ride request environment in which aspects of various embodiments can be implemented.

FIGS. 2A and 2B illustrate an example updated segment option for a reserved journey that can be determined during the course of the journey in accordance with various embodiments.

FIGS. 3A, 3B, and 3C illustrate an example notification flow indicating automatic rebooking of a connection or subsequent journey segment based on a determined state of a current segment that can be generated which aspects of various embodiments can be implemented.

FIG. 4 illustrates an example approach for matching ride requests to vehicle capacity that can be utilized in accordance with various embodiments.

FIG. 5 illustrates a high level process of a universal access system to provide access and payment of a multi-segment journey according to various embodiments.

FIGS. 6A-D illustrate an example multi-segment ride request flow indicating various segments and access to each transportation mode that can be generated which aspects of various embodiments can be implemented.

FIG. 7 illustrates a high level process of a universal access system to provide access and payment of a multi-segment journey according to various embodiments

FIG. 8 illustrates an example system that can be utilized to implement aspect of the various embodiments.

FIG. 9 illustrates an example process for determining routing options for a plurality of ride or transport requests that can be utilized in accordance with various embodiments.

FIG. 10 illustrates an example computing device that can be utilized to submit trip requests and receive route options in accordance with various embodiments.

FIG. 11 illustrates example components of a computing device that can be utilized to implement aspects of the various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Approaches described and suggested herein relate to the providing of transportation between specified locations. In particular, various embodiments provide approaches for determining and selecting from possible routing solutions, of one or more modes of transportation, to serve a set of transportation requests. The requests can relate to the transportation of people, animals, packages, or other objects or passengers, from an origination location to a destination location. The requests may also include at least one time component, such as a requested time of departure or arrival. The request may also include pricing and payment components, such as specifying a maximum cost for any requested route or a preferred payment (e.g., credit card, debit card). A provider, such as a transportation service, can utilize a routing determination process, for example, to balance various metrics when selecting between proposed routing solutions to serve a set of customer trip requests. One or more optimization processes can be applied, which can vary the component values or weightings of the routing process in order to attempt to improve the options generated and/or selected for each proposed routing solution. A solution can be selected for implementation based at least in part upon the resulting quality scores of the proposed routing solutions. The solution can also include coordinating payment for each of the transportation services utilized in the proposed routing solutions based on the payment and pricing components from the request.

In at least some embodiments, the routes selected between a point of origin and a destination can include at least two legs or segments, which can be provided by the same or different modes of transportation. A customer can submit a request for transportation between an origin and a destination at, or near, a specified time, and can receive information for traveling options along one or more routes between those locations. In at least some embodiments, a customer can select then select one or more options for the journey. The transportation for the selected option(s) can then be booked, such that sufficient capacity is reserved for the rider using the payment components specified in the request. Subsequently, such as during one of the segments of the journey, a determination can be made that the rider, based on the current state and conditions for the journey, will be unable to make the connection for the next segment of the journey, and the payment to the different transportation services can be coordinated seamlessly so that the rider immediately has access. Approaches in accordance with various embodiments can then use the estimated time of arrival, along with other criteria and conditions discussed herein, to determine alternate options for at least the next segment of the journey. One of the options will be selected for the segment, and the rider can be automatically rebooked on the vehicle for the next segment by automatically providing payment to the transportation service of the next segment. The rider can then be notified of the change so that the rider boards the correct vehicle, etc., and does not need to worry about a missed connection or lack of access to that transportation service because of payment. Segments can be rebooked for other reasons as well, such as to take advantage of newly available capacity for the segment.

Various other such functions can be used as well within the scope of the various embodiments as would be apparent to one of ordinary skill in the art in light of the teachings and suggestions contained herein.

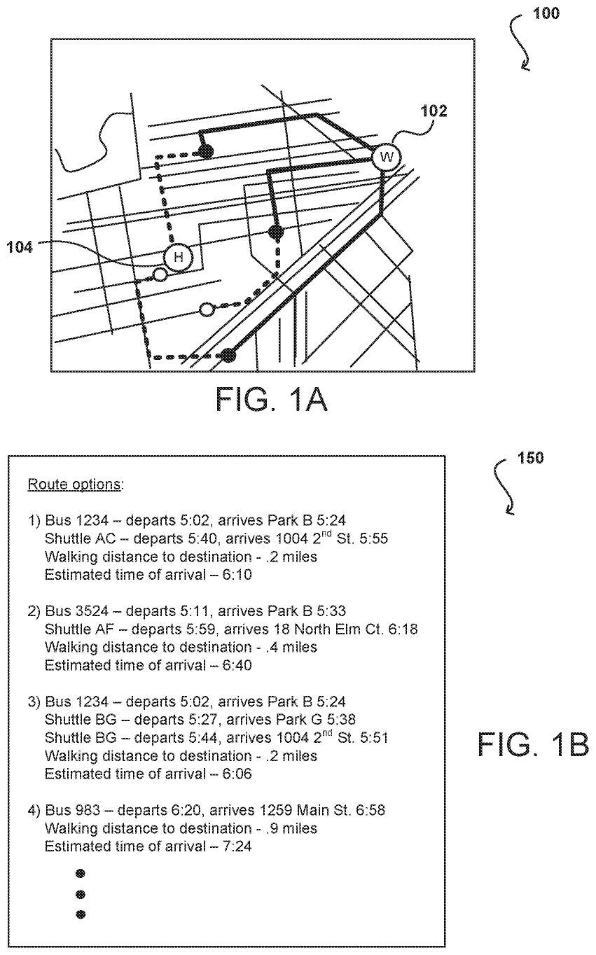

FIG. 1A illustrates an example location 100 in which aspects of the various embodiments can be implemented. In this example, a user can request transportation from an origination location 102 to a destination location 104 using, for example, an application executing on a client computing device. Various other approaches for submitting requests, such as by messaging or telephonic mechanisms, can be used as well within the scope of the various embodiments. Further, at least some of the requests can be received from, or on behalf of, an object being transported or scheduled to be transported. For example, a client device might be used to submit an initial request for an object, package, or other deliverable, and then subsequent requests might be received from the object, for example, or a device or mechanism associated with the device. Other communications can be used in place of requests, as may relate to instructions, calls, commands, and other data transmissions. For various embodiments discussed herein a “client device” should not narrowly be construed as a conventional computing device unless otherwise stated, and any device or component capable of receiving, transmitting, or processing data and communications can function as a client device in accordance with various embodiments.

The transportation can be provided using one or more vehicles (or other modes of transportation) capable of concurrently transporting one or more riders. While riders as used herein will often refer to human passengers, it should be understood that a “rider” in various embodiments can also refer to a non-human rider or passenger, as may include an animal or an inanimate object, such as a package for delivery. The rides provided to an individual rider from the point of departure to the point of arrival may also involve one or more vehicles, which may be of the same or different types, for the same or different modes of transportation. For example, in FIG. 1A a customer of a transportation service might want to use the service to obtain transport from the origination location 102 or point of departure, such as the customer's place of employment, to the destination location 104 or point of arrival, such as the user's home. Various other types of locations or ways of specifying locations can be used as well within the scope of the various embodiments. There may be modes of transportation offered that use fixed routes (such as trains or public buses), semi-fixed routes (such as shuttle buses), flexible routes (such as rideshares in passenger vehicles), or complete flexibility (such as e-bikes or scooters), among other such options. While more flexible options, such as ride shares, may provide for the shortest travel times in some situations, they may also come at a higher cost than fixed route options, such as subways or public buses. Further, flexible route options such as rideshares may be subject to traffic congestion or other issues that may introduce additional uncertainty into arrival times, etc.

For at least some of these reasons, customers or riders may choose to take fixed route transportation for at least some of their journey. For example, a customer might take a public bus out of downtown due to the relatively low cost and frequent availability of the buses. These buses can go to one or more stops from which the customer can obtain a connecting transport if needed, or desired, to complete a remainder of the journey. In many instances, a customer might want flexibility in the timing of the bus or initial mode of transport, such as to be able to catch the next available bus along a given route. A customer might also want to be able to select from multiple available routes to obtain additional options. As illustrated in FIG. 1A, there may be a number of bus routes (illustrated using the solid lines) that go from a destination, such as a bus stop near the customer's place of employment, to one or more destinations along substantially fixed routes. The customer may be willing to take any of these routes from the point of origin 102, particularly at rush hour or in inclement weather, etc.

In some embodiments discussed herein, a customer can view potential options for routes that involve multiple legs or segments. The multiple legs or segments may be traveled by using various types of transportation. The customer can then select a particular option that is most desirable or of interest to him/her, or at least most closely satisfies the customer's current selection criteria, which may include, for example, timing and price. An example presentation 150 of a set of options is illustrated in FIG. 1B. In this example, the customer is able to view a number of different options that satisfy, or otherwise at least partially match, one or more search criteria submitted by the customer for a future transportation need. As illustrated, the options can include different times of departure from a specified location at, or close to, the customer's requested time. The options include different options for the initial leg, here including different buses that travel at different times and/or to different locations. From those locations, there are different options presented to continue on towards the destination. These include not only different connection options, such as different shuttles, but also include options for walking or biking certain distances, etc. A user can select from among these options, and a transportation service or other entity system providing the options can cause corresponding reservations to be made for the selected options. The transportation service or other entity system providing the options can also determine a suitability of a vehicle, such as, for example, a rideshare vehicle for use by a customer. Some parameters that may be used for determining the suitability of a vehicle may include a capacity of a vehicle, a number of riders who have made reservations in the vehicle when the vehicle is a rideshare vehicle, and acceptance of a universal access system for payment and access.

According to various embodiments, a customer may use a universal access card that is configured to provide payment to all the different transportation services as well as provide customer access to all the different transportation services. In an exemplary embodiment, the universal access card is a multi-functional card that provides a payment mode of use and an access mode of use, the payment mode of use useable by the customer to make payments, and the access mode of use useable by the customer to enter one or more vehicles for traveling on a multi-segment route. The access card may be a physical card configured to communicate with various transportation services and payment processing services, and/or may be linked to the customer's payment information (e.g., credit card, debit card, bank information, electronic bank or payment service). In another embodiment, the universal access card may be included in a software application provided in a customer's smartphone or other personal device (tablet, laptop, key fob, etc.). According to embodiments described herein, the universal access card may also be enabled to allow the customer to make reservations for various modes of transportation with different transportation services. Since ride-sharing transportation services are request-based, there may not be a kiosk or computing device to capture information about access by the customer to a transportation service unlike what is available in a public transportation service bus or train. The universal access card may be associated with a customer's transportation service account(s) as well as the customer's payment information. The customer may only be charged when the customer actually accesses that transportation service, even when the customer has selected a proposed route that includes that transportation service. For example, if the selected route option includes a ride share and a bus, the universal access card may coordinate with the ride sharing service to pay for and pick up the customer for the first segment and subsequently for the next segment, enable the card to allow the customer to access the bus system. However, the customer may change his or her mind and not take the bus; in this situation, while the universal card was enabled to provide access to the customer, the customer will not be charged for the bus segment if the customer does not tag the universal access card into the bus system.

In another embodiment, the universal access card may have the entire journey, including all segments and associated transportation services, paid upfront upon the customer initiating the journey (i.e., once the customer taps or logs into the first segment of the journey) as a means to “hold” the reservation. Alternatively, the reservation for various transportation services for segments may be held for the customer when the customer initiates the journey, but the payment for those services may not be made in full until the customer actually begins that segment of the journey and utilizes the associated transportation service. In this manner, the customer is not charged for travel segments that the customer did not take as a result of delay, missed transfers or connections, or other situations. However, if the customer is late, missed, or did not show for a particular segment for a reserved transportation service such as a ride share, the customer's account may be terminated, suspended, or penalized if the number of no-shows exceeds a threshold amount. Alternatively, the customer may be charged for travel segments that should have been made by the customer if not for the customer's own personal tardiness or cancellation/no-show.

In some instances, a rider may begin a journey by boarding a vehicle or transport for the first segment of the journey. This can include, for example, boarding a bus or train that is leaving from, or near, the origin point of the journey. As discussed elsewhere herein, the rider might confirm that the rider has boarded a particular vehicle using the universal access card. The universal access card, according to some embodiments, may be operable in an access mode and a payment mode. The universal access card may automatically switch modes depending on the applicable transportation service and associated payment service, or may manually switch modes by the customer pushing a button or other setting on the universal access card. For example, the access card may be operable as a debit or credit card for applicable transportation services or as an access card (e.g., subway or bus pass) that can be tagged on a receiver or kiosk for that particular transportation service. In alternative embodiments, the universal access card may be operated through an application in a smartphone, such as through manual input into a transportation app, through tapping a sensor or scanning a code upon entering the vehicle, or through the providing of geo-location data through a rider's portable computing device, among other such options.

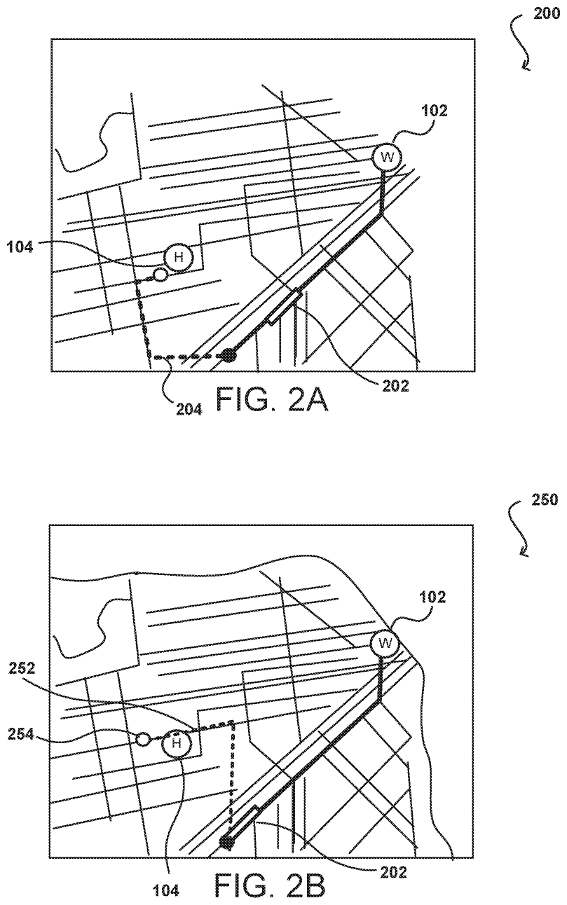

A transport provider system can then monitor or track information about the current segment in progress to update estimates for the time of arrival of the vehicle at a specified location. As illustrated in the example situation 200 of FIG. 2A, a vehicle 202 might be traveling upon a determined route from the origination location 102 to an endpoint for the first segment. A second segment 204 of the journey might be served by a separate vehicle that is scheduled to leave at a specified time. The transportation service can monitor information for the first vehicle 202 to determine whether the first vehicle will arrive at the connection point in time for the rider to make a connection to the second vehicle for the second segment 204 of the journey. The universal access card may, based on the determined route, coordinate with the different transportation services for each segment of the journey to enable the universal access card to make payment and provide access to the transportation service for each segment of the route.

According to one embodiment, it might be the case that the service determines that there will be insufficient time for the rider to make the connection for the second segment based on the current state of the first vehicle 202. The current state might involve a current location and/or velocity of the vehicle, as well as factors such as traffic or construction, that can impact the estimated time of arrival. In order to be determined to have sufficient time for a connection, the first vehicle 202 might have to be estimated to arrive at the connection point before the scheduled departure of the second vehicle from the connection point, and in many embodiments will also have to allow for a buffer of one to two minutes, or more, to enable the rider to make the connection. This can include time to disembark from the first vehicle, walk or transfer to the second vehicle, then board the second vehicle before the scheduled time. If the system determines that the first vehicle for the first segment in this example will not reach the connection point at a time that satisfies the above criteria, or other such criteria, then the transportation service can determine that the rider is unlikely to make the reserved connection.

Accordingly, approaches in accordance with various embodiments can provide for an automatic rebooking of, and enabling access to, one or more subsequent segments of a journey with the corresponding transportation service, such as when a current state of the journey, or a specific segment of the journey, satisfies at least one rebooking criterion. Additionally, although the universal access card may be enabled to make payment for each transportation service rebooked for each segment, the payment instrument may only be charged when the rider actually logs into, scans, or begins that segment of the journey with the associated transportation service. So in the situation where the route is change and a segment of the journey may be altered, the universal access card may coordinate to enable payment to the next determined transportation service for the updated route and will not charge the customer for the original segment and transportation service. This can include, for example, a determination that a rider will be unable, or at least unlikely with a certain certainty, to make the reserved connecting segment. This can be based upon estimated time of arrival or progress along the current segment, or other metrics discussed and suggested herein. A transportation management service, or transportation booking system, etc., can determine an estimated time of arrival of a vehicle for a current segment of the journey at a connection point, and can attempt to determine one or more options for completing the journey from that location at that time. The option determination process can be similar to others discussed and suggested herein, although there may be other criteria or options applied in the case of a missed connection. For example, a rebooking that is the fault of a transit company that will cause the rider to be more than a threshold amount of time late to the target destination might warrant a different class or type of service, or a discount in pricing, among other such options, that may be automatically applied with the universal access card.

In the example situation 250 illustrated in FIG. 2B, the transportation service can cause a new reservation to be made for the rider, or a current reservation updated, to reserve capacity on a different route option, here including a different route 252 on a different vehicle that leaves at a later time, but still will drop the rider at an end location 254 near the destination location 104. In some embodiments the user might have to confirm the rebooking and payment, or select from among a set of rebooking and payment options, while in other embodiments the rebooking and payment may occur automatically, with the rider being notified of the route and price change such that the rider knows to look for a different vehicle, route, or pickup location, etc. In some embodiments where a rider may not receive information about the connection until the rider is at, or near, the connection point, the rebooking may occur without knowledge of the rider, who will still be able to check for connection information at the same time, and will not necessarily know or be able to determine that the information provided is different from earlier determined information. If there is more than one subsequent segment, any or all of these subsequent segments can be rebooked as appropriate for completing the journey.

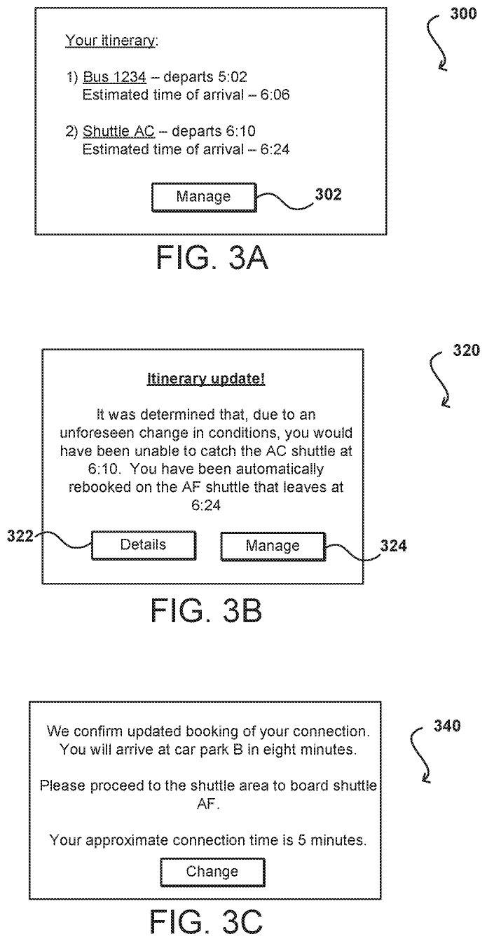

FIGS. 3A through 3C illustrate an example message flow that can be provided for display to a customer, rider, or other such entity in accordance with various embodiments. In this example, a customer can submit a ride request and, if required, select from various options in order to obtain a final itinerary 300, such as is displayed in the view of FIG. 3A. This information might be provided through a screen displayed via a transportation app, among other such options. This information includes at least the identity of the vehicle to board for each segment of the journey, as well as timing information, price and payment information, and/or access information. Various other information can be displayed as well as discussed and suggested elsewhere herein. The display can include one or more selectable elements 302 that enable the rider to manage the booking, such as to adjust time, location, price options or segment options, etc. The system for the transportation service can store information for the itinerary, booking, or reservation, and can also monitor the progress and state of the journey. This can include, for example, determining when a rider has boarded or otherwise taken a capacity on a specified vehicle for a segment of the journey, as well as determining the progress of the vehicle along the segment. As discussed, this can include updating the estimated time of arrival of the vehicle at a connection point, or other such destination, based at least in part upon the current location of the vehicle and conditions between the vehicle and the destination.

In this example the transportation service has determined that the rider will be unable to make the vehicle upon which the rider has reserved capacity for the next segment of the journey. Accordingly, the service can determine a new option for the next segment that will enable the rider to complete the journey based on the time that the rider will arrive at the next connection point. This may include a different vehicle and/or different route that may leave at a different time and/or different location and have different pricing or payment information, or access information (e.g., tag card upon boarding, or tag card at kiosk to retrieve ticket, etc.). Once determined, a notification 320 of the change can be provided for display to the rider, such as is illustrated in the example interface view of FIG. 3B. This notification provides basic information for the change, including enough information for the rider to be able to make the proper connection to the newly reserved vehicle. In this example there can be an option 324 to manage aspects of the booking, as discussed above, as well as an option to obtain more detail as to the new or updated booking for the journey, including information for at least the modified next segment. If the rider selects the option to view more information, another interface display 340 can be rendered as illustrated in FIG. 3C that provides more detail about the connection, including updated connection time, time or arrival, and the like. Various other types of information can be displayed as well within the scope of the various embodiments.

In at least some embodiments, a customer can provide permissions that enable the universal access card to modify a reservation, including booking, updating, or automatically rebooking as appropriate, or at least under permitted condition. The permissions set by the customer with the universal access card service may also allow for only certain types of rebooking, such as rebooking of future segments of a current journey that are required to complete the journey, accept a certain form of payment, and/or are within a determined price threshold. In some embodiments a transportation service may receive permission to rebook any time the new option is better than a currently reserved option, potentially by at least a determined or threshold account, based on current or anticipated conditions. This can be due to a new seat coming available, a rider being ahead of schedule, a better price, or a vehicle for a segment being behind scheduled, among other such options. The rebooking of a specified segment can also trigger the universal access card to rebook and pay transportation services of other segments of a multi-segment journey as appropriate, or as improved alternatives are discovered. In some embodiments a customer might select an option in a transportation application associated with the universal access card to check whether a better option has become available, or to adjust criteria in order to attempt to find an alternate route, etc.

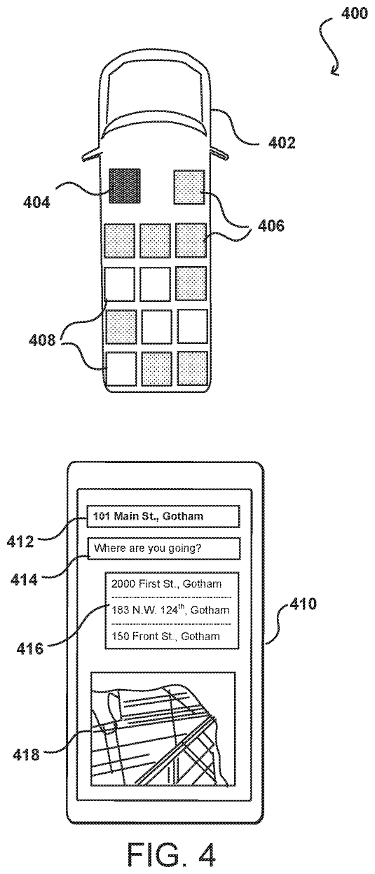

Various systems and services can be used to implement aspects of the invention as discussed and suggested herein. A transport service that provides vehicles that can concurrently be used by more than one rider is often referred to as a “rideshare” service, although as discussed vehicles such as bikes and scooters can be utilized as well which may only serve one customer at a time in at least some embodiments. In one example, a rideshare service can offer routes using at least one type of vehicle 402 that includes space 404 for a driver and seats or other capacity for up to a maximum number of riders, as illustrated in the example configuration 400 of FIG. 4. It should be understood that various types of vehicles can be used with different numbers or configurations of capacity, and that autonomous vehicles without dedicated drivers can be utilized as well within the scope of the various embodiments. Vehicles such as smart bicycles or personal transport vehicles may be used as well, which may include seating capacity for only a single rider or limited number of passengers. For a given vehicle on a given route, a number of available seats 406 (or other rider locations) may be occupied by riders, while another number of seats 408 may be unoccupied. In some embodiments objects such as packages or deliveries may also occupy available space for a ride as well, which can include areas for seating or cargo, or convertible space, among other such options. In order to improve the economics of the rides offered, it can be desirable in at least some embodiments to have the occupancy as close to full as possible during the entire length of the trip. Such a situation results in very few unsold seats, which improves operational efficiency. One way to achieve high occupancy might be to offer only fixed routes where all passengers board at a fixed origination location and off-board at a fixed destination location, with no passengers onboarding or off-boarding at intermediate locations.

A user can request transportation from an origination to a destination location using, for example, an application executing on a client computing device 410. Various other approaches for submitting requests, such as by messaging or telephonic mechanisms, can be used as well within the scope of the various embodiments. Further, at least some of the requests can be received from, or on behalf of, an object being transported or scheduled to be transported. For example, a client device might be used to submit an initial request for an object, package, or other deliverable, and then subsequent requests might be received from the object, for example, or a device or mechanism associated with the device. Other communications can be used in place of requests, as may relate to instructions, calls, commands, and other data transmissions. For various embodiments discussed herein a “client device” should not narrowly be construed as a conventional computing device unless otherwise stated, and any device or component capable of receiving, transmitting, or processing data and communications can function as a client device in accordance with various embodiments.

The transportation can be provided using a vehicle 402 (or other object) capable of concurrently transporting one or more riders. While riders as used herein will often refer to human passengers, it should be understood that a “rider” in various embodiments can also refer to a non-human rider or passenger, as may include an animal or an inanimate object, such as a package for delivery. In this example, a rideshare service offers routes using at least one type of vehicle that includes space 404 for a driver and seats or other capacity for up to a maximum number of riders. It should be understood that various types of vehicles can be used with different numbers or configurations of capacity, and that autonomous vehicles without dedicated drivers can be utilized as well within the scope of the various embodiments. In order to improve or maximize the economics of the rides offered, it can be desirable in at least some embodiments to have the occupancy or utilization as close to full as possible during the entire length of the trip. Such a situation results in very few unsold seats, or little unsold capacity, which improves operational efficiency. One way to achieve high occupancy might be to offer only fixed routes where all passengers board at a fixed origination location and off-board at a fixed destination location, with no passengers onboarding or off-boarding at intermediate locations. As mentioned, such an approach may be beneficial for at least one segment of a given customer journey.

In the present example, a given user can enter an origination location 412 and a destination location 414, either manually or from a set of suggested locations 416, among other such options, such as by selecting from a map 418 or other interface element. In other embodiments, a source such as a machine learning algorithm (or trained neural network, etc.) or artificial intelligence system can select the appropriate locations based on relevant information, such as historical user activity, current location, and the like. Such a system can be trained using historical ride data, and can learn and improve over time using more recent ride and rider data, among other such options. A backend system, or other provider service, can take this information and attempt to match the request with a specific vehicle having capacity at the appropriate time. As known for such purposes, it can be desirable to select a vehicle that will be near the origination location at that time in order to minimize overhead such as fuel and driver costs. As mentioned, the capacity can include a seat for a human rider or sufficient available volume for a package or object to be transported, among other such measures of capacity.

Such an approach may not be optimal for all situations, however, as it may be difficult to get enough users or object providers to agree to be at a specific origination location at a specific time, or within a particular time window, which can lead to relatively low occupancy or capacity utilization, and thus low operational efficiency. Further, such an approach may result in fewer rides being provided, which may reduce overall revenue. Further, requiring multiple users to travel to a specific, fixed origination location may cause those users to utilize other means of transportation, as may involve taxis or dedicated rideshare vehicles that do not require the additional effort. Accordingly, it can be desirable in at least some embodiments to factor rider convenience into the selection of routes to be provided. What may be convenient for one rider, however, may not be convenient for other riders. For example, picking up one rider in front of his or her house might add an additional stop, and additional route distance, to an existing route that might not be acceptable to the riders already on, or assigned to, that route. Further, different riders may prefer to leave at different times from different locations, as well as to get to their destinations within a maximum allowable amount of time, such that the interests of the various riders are at least somewhat competing, against each other and those of the ride provider. It therefore can be desirable in at least some embodiments to balance the relative experience of the various riders with the economics of the rideshare service for specific rides, routes, or other transportation options. While such an approach will likely prevent a ride provider from maximizing profit per ride, there can be some middle ground that enables the service to be profitable while providing (at a minimum) satisfactory service to the various riders or users of the service. Such an approach can improve the rider experience and result in higher ridership levels, which can increase revenue and profit if managed appropriately.

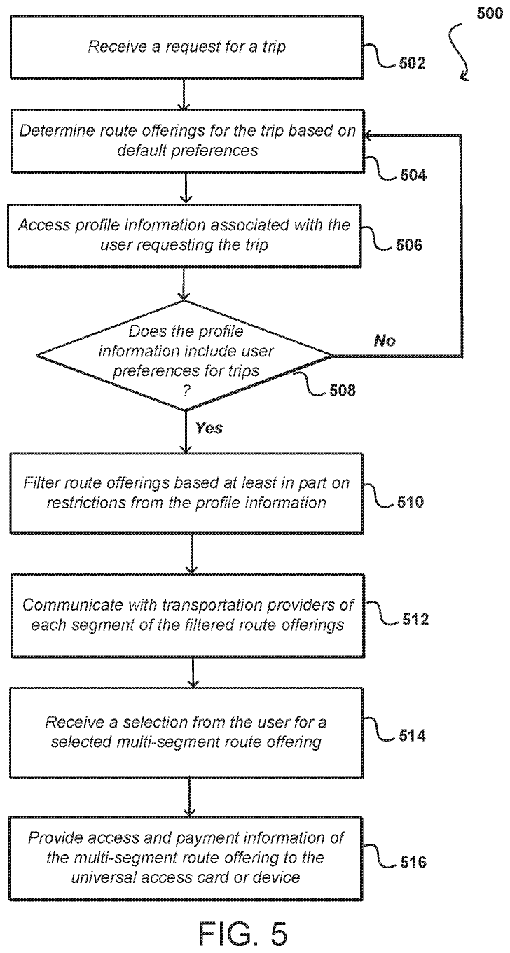

FIG. 5 illustrates an example process 500 for providing access and payment to different transportation modes for a multi-segment journey according to various embodiments. It should be understood that, for this and other processes discussed herein, there can be additional, fewer, or alternative steps, performed in similar or alternative steps, or in parallel, within the scope of the various embodiments unless otherwise stated. In this example, a request is received 502 for a journey that involves at least two segments, or will potentially involve more than one segment for at least some options. The request can be received to a system for an appropriate entity, such as a transportation service provider. As discussed herein, the transport for one or more segments of a journey may be provided by an entity other than the transportation service provider, and can include public entities or other third party entities that may have a contractual relationship with the service provider. A number of such requests can be received from, or on behalf of, various potential customers of the transportation service provider. The requests in this example relate to a future period of time, for at least one specified service area or region, in which the transport is to occur for one or more persons, animals, packages, or other objects or passengers. The requests can be submitted through an application executed on a computing device in many embodiments, although other request mechanisms can be used as well.

In order to determine how to best serve the received request, this example process first determines 504 a set of route offerings satisfying the criteria for the journey. The criteria can include, for example, at least an approximate journey start time and location, as well as a target destination location. Other criteria can be provided or utilized as well, including many of those discussed and suggested elsewhere herein. For example, a price maximum for the route, preferred transportation modes, etc. In some embodiments, the criteria may be set by the rider, and if there are no custom criteria, the route offerings may be determined based on default criteria. The process can involve determining available vehicle capacity for serving the requests. This can include, for example, determining which vehicles or transport mechanisms are available to that service area over the specified future period of time, as well as the available seating or other capacity of those vehicles for that period of time. As mentioned, in some embodiments at least some of the seats of the various vehicles may already be committed or allocated to specific routes, riders, packages, or other such options.

Based at least in part upon the various available vehicles and capacity, a set of potential routing options can be determined. This can include, for example, using one or more route determination algorithms that are configured to analyze the various origination and destination locations, as well as the number of passengers and corresponding time windows for each, and generate a set of routing solutions for serving the various requests. The potential solutions can attempt to allocate vehicles to customers based on, for example, common or proximate origination and destination locations, or locations that can be served by a single route of a specific vehicle. In some embodiments a routing algorithm can potentially analyze all possible combinations for serving the requests with the available vehicles and capacity, and can provide any or all options that meet specific criteria, such as at least a minimum utilization or profitability, or at most a maximum allowable deviation (on average or otherwise) from the parameters of the various customer requests. This can include, for example, values such as a distance between the requested origination location and a suggested pick up point, deviations from a requested time, and the like. In some embodiments all potential solutions can be provided for subsequent analysis. Further, for multi-segment routing options, the route determination algorithm can take into account possible connection points, as well as the possible routing options from those connection points to the target destination, including the appropriate time windows for each.

The determined routing options can be processed and/or optimized to attempt to identify an optimal routing option, or a set of highest ranked routing options, among other such approaches. Profile information specific to the identified user requesting the trip can be accessed 506 to the universal access system. In another embodiment, the profile information may be transmitted to the universal access system by the requesting rider providing the information through an application operating on a smartphone of the requesting rider. The information in some embodiments can provide one or more options for the user to select or confirm, in order to confirm a reservation or booking of a seat or other amount of capacity on the selected option for any or all segments of the journey, including price and payment information.

In this example, it may be determined whether the user profile information includes user preferences that may be utilized in determining the route offerings for the ride request 508. As mentioned, this may include manually set criteria by the user (e.g., price maximum, preferred transportation modes, preferred payment methods) or may involve accessing a user profile database. The user profile database may include historical information about the identified user's pattern of behavior to determine the user's preferred transportation mode, the average price per ride, the average number of segments, typical start and end points, the typical number of passengers, etc. If there is insufficient profile information to determine user preferences, then the route offerings may be based on default preferences 504. If there are determined user preferences, then the route offerings may be filtered based at least in part on the restrictions from the profile information and/or user preferences in 510.

At a subsequent point in time, different transportation providers of each of the multiple segments of each route offerings may be contacted 512 to coordinate access and payment. In some embodiments, the communication to various transportation providers may be conducted after the rider selects a specific route offering. In other embodiments, the coordination with various transportation providers may be conducted prior to the rider's selection, so that when the rider selects an option, the rider may immediately access the first transportation provider and initiate the first segment of the trip. As discussed herein, a rider may have a universal access card provided by the universal transportation access system of the present application. The universal access card may be configured to provide access and payment for the transportation providers for each segment of the route that is selected by the requesting rider, or the route offerings that are filtered based on profile information and/or user preferences.

The filtered route offerings and access provided may also be based upon a fixed schedule for the segment, maximum price for the trip, preferred transportation mode, or may be based upon more dynamic information such as current location, traffic, or other factors that are used to determine a more accurate time of arrival for the current segment. The filtered route offerings provided can include estimated times as well, such that for the segment, travel can be monitored and updated throughout at least a portion of the segment transit in order to have the most accurate and up-to-date arrival information. Other embodiments may include analyzing journey criteria such as type of vehicle, number of stops, type of seating or capacity, and the like. The segment selection in at least some embodiments also has to fit within the overall journey criteria, such that a segment may not be selected if it would require a third segment for the journey, but the journey criteria required no more than one connection or two total segments (other than potentially walking, etc.). Once the options are determined, including any optimization or ranking, etc., then in this example the optimal, highest ranked, or other preferred option can be determined and transportation for the next segment of the journey can be booked for the rider according to the selected alternate option. It can subsequently be determined that the customer has completed the journey, and data for the journey can be stored for future analysis, such as to determine transportation performance or customer preferences, etc.

Upon reviewing the filtered routed offerings in 510, the user may select a multi-segment route offering from the display. The universal access system may receive the selection from the user for a particular multi-segment route offering from the filtered set 514. As mentioned, the universal access system may already have communicated or be in communication with the transportation providers 512 so that when the user makes a selection in 514, the selected route is ready for the user to begin. Subsequently, the universal access system may communicate with the universal access card of the suer to provide access and payment information of the selected multi-segment route offering 516. In some embodiments, this may include loading the universal access card with sufficient funds for that particular segment, or for the whole journey including all segments. Providing access may involve transmitting account information such that when the universal access device or card is tapped at a kiosk of a particular transportation provider, the transportation provider recognizes the account as a user who has paid and has access to that particular transportation mode.

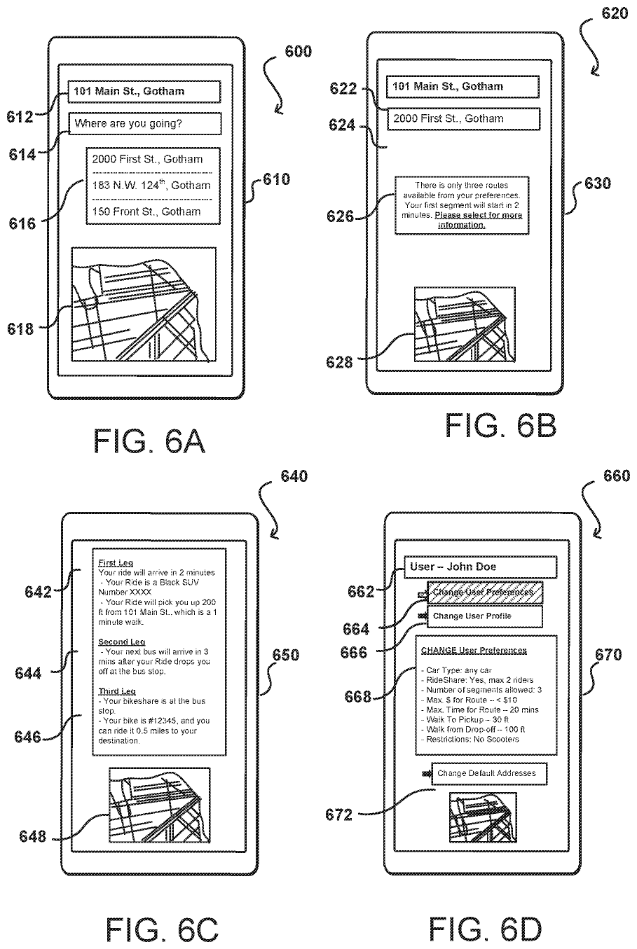

FIGS. 6A-6D illustrate example user interfaces that portray providing such service in accordance with various embodiments. In the example user interface 600 of FIG. 6A displayed on a computing device 610, a mapping 618 indicate an area including the requested origination point 612 and requested destination point 614. As illustrated, there are clusters of alternate locations 616 where users may want to be delivered, or objects are to be delivered, as may correspond to town centers, urban locations, or other regions where a number of different businesses or other destinations are located. In example user interface 620 displayed on computing device 620 of FIG. 6B, once the origination point 622 and destination point 624 are determined and set by the user, the display may include a message 626 that there are multiple route offerings shown in mapping 628 for the requested trip from origination 622 to destination 624. In some embodiments, one transportation provider for one segment may be a ride-sharing transportation service. Economically, it may not be practical for a multi-rider vehicle service to provide each person a dedicated vehicle for the determined route, as the overall occupancy per vehicle would be very low. Ensuring full occupancy for each vehicle, however, can negatively impact the experience of the individual riders who may then have to have longer routes and travel times in order to accommodate the additional riders, which may cause them to select other means of transportation. Similarly, requiring a large number of passengers to meet at the same origination location may be inconvenient for at least some of those passengers, who may then choose alternate travel options.

It thus can be desirable, in at least some embodiments, to provide routes and transportation options that balance, or at least take into consideration, these and other such factors. As an example, the user interface 640 of FIG. 6C includes a mapping 648 displayed on computing device 650. The user interface 640 illustrates a route with multiple segments 642, 644, 646. Each segment may include the estimated time of arrival, when the user should depart for the segment, pricing information, and/or transportation provider or mode. Each segment can also be served by one or more vehicles or modes of transportation, each servicing a portion or segment of a given route. The user interface 660 displayed on the computing device 670 is an example of a user 662 being able to change preferences 668, including preferred payment, mode of transportation, maximum price, etc. Other criteria or settings that the user can modify include changing a default address 672. The user may be enabled to change user profile information 666 or change user preferences 664 for ride requests. The information in the user profile and user preferences may be used as criteria to determine or filter route offerings to the user when the user requests a ride.

In order to determine the routes to provide, as well as the vehicles (or types of vehicles) to use to provide those routes, various factors can be considered as discussed and suggested herein. A function of these factors can then be optimized in order to provide for an improved customer experience, or transport experience for transported objects, while also providing for improved profitability, or at least operational efficiency, with respect to other available routing options. The optimization approaches and route offerings can be updated over time based on other available data, as may relate to more recent ride data, ridership requests, traffic patterns, construction updates, and the like. In some embodiments an artificial intelligence-based approach, as may include machine learning or a trained neural network, for example, can be used to further optimize the function based upon various trends and relationships determined from the data as discussed elsewhere herein.

Approaches in accordance with various embodiments can utilize at least one objective function to determine route options for a set of vehicles, or other transportation mechanisms, for one or more regions of service or coverage. At least one optimization algorithm can be applied to adjust the various factors considered in order to improve a result of the objective function, such as to minimize or maximize the score for a set of route options. The optimization can apply not only to particular routes and vehicles, for example, but also to future planned routes, individual riders or packages, and other such factors. An objective function can serve as an overall measure of quality of a routing solution, set of proposed routing options, or past routing selections. An objective function serves as a codification of a desire to balance various factors of importance, as may include the rider's convenience or experience, as well as the service delivery efficiency for a given area and the quality of service (QoS) compliance for specific trips, among other such options. For a number of given origination and destination locations over a given period of time, the objective function can be applied and each proposed routing solution given a score, such as an optimized route score, which can be used to select the optimal routing solution. In some embodiments the routing option with the highest route score will be selected, while in other embodiments there can be approaches to maximize or minimize the resulting score, or generate a ranking, among various other scoring, ranking, or selection criteria. Routing options with the lowest score may be selected as well in some embodiments, such as where the optimization function may be optimized based on a measure of cost, which may be desirable to be as low as possible, versus a factor such as a measure of benefit, which may be desirable to be as high as possible, among other such options. In other embodiments the option selected may not have the optimal objective score, but has an acceptable objective score while satisfying one or more other ride selection criteria, such as may relate to operational efficiency or minimum rider experience, among others. In one embodiment, an objective function accepts as inputs the rider's convenience, the ability to deliver confirmed trips, the fleet operational efficiency, and the current demand. In some embodiments, there will be weightings of each of these terms that may be learned over time, such as through machine learning. The factors or data making up each of these terms or value can also change or be updated over time.

Component metrics, such as the rider's convenience, QoS compliance, and service delivery efficiency can serve at least two purposes. For example, the metrics can help to determine key performance indicator (KPI) values useful for, in some embodiments, planning service areas and measuring their operational performance. Performance metrics such as KPIs can help to evaluate the success of various activities, where the relevant KPIs might be selected based upon various goals or targets of the particular organization. Various other types of metrics can be used as well. For instance, locations for which to select service deployment can be considered, such as where a service area (e.g., a city) can be selected, and it may be desired to develop or apply a deployment or selection approach that is determined to be optimal, or at least customized for, the particular service area. Further, these metrics can help to provide real-time optimization goals for the routing system, which can be used to propose or select routes for the various requests. The optimization may require the metrics in some embodiments to be calculated for partial data sets for currently active service windows, which may correspond to a fixed or variable period of time in various embodiments.

As an example, a rider's convenience score can take into account various factors. One factor can be the distance from the rider's requested origination point to the origination point of the selected route. The scoring may be performed using any relevant approach, such as where an exact match is a score of 1.0 and any distance greater than a maximum or specified distance achieves a score of 0.0. The maximum distance may correspond to the maximum distance that a user is willing to walk or travel to an origination location, or the average maximum distance of all users, among other such options. For packages, this may include the distance that a provider is willing to travel to have those packages transported to their respective destinations. The function between these factors can vary as well, such as may utilize a linear or exponential function. For instance, in some embodiments an origination location halfway between the requested and proposed origination locations might be assigned a convenience score of 0.5, while in other approaches is might earn 0.3 or less. A similar approach may be taken for time, where the length of time between the requested and proposed pickups can be inversely proportional to the convenience score applied. Various other factors may be taken into account as well, as may include ride length, number of stops, destination time, anticipated traffic, and other such factors. The convenience value itself may be a weighted combination of these and other such factors.

Optimizing, or at least taking into consideration, a rider's convenience metric can help to ensure that trips offered to the riders are at least competitively convenient. While rider convenience may be subjective, the metric can look at objective metrics to determine whether the convenience is competitive with respect to other means of transportation available. Any appropriate factors can be considered that can be objectively determined or calculated using available data. These factors can include, for example, an ability (or inability) to provide various trip options. The factors can also include a difference in the departure or arrival time with respect to the time(s) requested by the riders for the route. In some embodiments a rider can provide a target time, while in others the riders can provide time windows or acceptable ranges, among other such options. Another factor can relate to the relative trip delay, either as expected or based upon historical data for similar routes. For example certain routes through certain high traffic locations may have variable arrival times, which can be factored into the convenience score for a potential route through that area or those locations. Another factor may relate to the walking (or non-route travel) required of the user for a given route. This can include, as mentioned, the distance between the requested origin and the proposed origin, as well as the distance between the requested destination and the proposed destination. Any walking required to transfer vehicles may also be considered if appropriate.

Various other factors can be considered as well, where the impact on convenience may be difficult to determine but the metrics themselves are relatively straightforward to determine. For example, the currently planned seating or object capacity utilization can be considered. While it can be desirable to have full occupancy or capacity utilization from a provider standpoint, riders might be more comfortable if they have some ability to spread out, or if not every seat in the vehicle is occupied. Similarly, while such an approach may not affect the overall ride length, any backtracking or additional stops at a prior location along the route may be frustrating for various riders, such that these factors may be considered in the rider's convenience, as well as the total number of stops and other such factors. The deviation of a path can also be factored in, as sometimes there may be benefits to taking a specific path around a location for traffic, toll, or other purposes, but this may also be somewhat frustrating to a user in certain circumstances.

Another factor that may be considered with the rider convenience metric, but that may be more difficult to measure, is the desirability of a particular location. In some embodiments the score may be determined by an employee of the provider, while in other embodiments a score may be determined based on reviews or feedback of the various riders, among other such options. Various factors can be considered when evaluating the desirability of a location, as may relate to the type of terrain or traffic associated with a spot. For example, a flat location may get a higher score than a location on a steep hill. Further, the availability, proximity, and type of smart infrastructure can impact the score as well, as locations proximate or managed by smart infrastructure may be scored higher than areas locations without such proximity, as these areas can provide for more efficient and environmentally friendly transport options, among other such advantages. Similarly, a location with little foot traffic might get a higher score than near a busy intersection or street car tracks. In some embodiments a safety metric may be considered, as may be determined based upon data such as crime statistics, visibility, lighting, and customer reviews, among other such options. Various other factors may be considered as well, as may relate to proximity of train lines, retail shops, coffee shops, and the like. In at least some embodiments, a weighted function of these and other factors can be used to determine a rider's convenience score for a proposed route option.

Another component metric that can be utilized in various embodiments relates to the quality of service (QoS) compliance. As mentioned, a QoS compliance or similar metric can be used to ensure that convenience remains uncompromised throughout the delivery of a route. There may be various QoS parameters that apply to a given route, and any deviation from those parameters can negatively impact the quality of service determined for the route. Some factors may be binary in their impact, such as the cancelation of a trip by the system. A trip is either canceled or performed, at least in part, which can indicate compliance with QoS terms. Modification of a route can also impact the QoS compliance score if other aspects of the trip are impacted, such as the arrival time or length of travel. Other factors to be considered are whether the arrival time exceeded the latest committed arrival time, and by how much. Further, factors can relate to whether origination or destination locations were reassigned, as well as whether riders had to wait for an excessive period of time at any of the stops. Reassignment of vehicles, overcapacity, vehicle performance issues, and other factors may also be considered when determining the QoS compliance score. In some embodiments the historical performance of a route based on these factors can be considered when selecting proposed routes as discussed herein.

With respect to service delivery efficiency, the efficiency can be determined for a specific service area (or set of service areas). Such a factor can help to ensure that fleet operations are efficient, at least from a cost or resource standpoint, and can be used to propose or generate different solutions for various principal operational models. The efficiency in some embodiments can be determined based on a combination of vehicle assignment factors, as may related to static and dynamic assignments. For a static vehicle assignment, vehicles can be committed to a service area for the entire duration of a service window, with labor cost being assumed to be fixed. For dynamic vehicle assignment, vehicles can be brought in and out of service as needed. This can provide for higher utilization of vehicles in service, but can result in a variable labor cost. Such an approach can, however, minimize driving distance and time in service, which can reduce fuel and maintenance costs, as well as wear on the vehicles. Such an approach can also potentially increase complexity in managing vehicles, drivers, and other such resources needed to deliver the service.

Various factors can be considered with respect to a service efficiency (or equivalent) metric. These can include, for example, rider miles (or other distance) planned by not yet driven, which can be compared with vehicle miles planned but not yet driven. The comparison can provide a measure of seating density. The vehicle miles can also be compared with a measure of “optimal” rider miles, which can be prorated based upon anticipated capacity and other such values. The comparison between vehicle miles and optimal rider miles can provide a measure of routing efficiency. For example, vehicles not only travel along the passenger routes, but also have to travel to the origination location and from the destination location, as well as potentially to and from a parking location and other such locations as part of the service. The miles traveled by a vehicle in excess of the optimal rider miles can provide a measure of inefficiency. Comparing the optimal rider miles to a metric such as vehicle hours, which are planned but not yet drive, can provide a measure of service efficiency. As opposed to simply distance, the service efficiency metric takes into account driver time (and thus salary, as well as time in traffic and other such factors, which reduce overall efficiency. Thus, in at least some embodiments the efficiency metrics can include factors such as the time needed to prepare for a ride, including getting the vehicle ready (cleaning, placing water bottles or magazines, filling with gas, etc.) as well as driving to the origination location and waiting for the passengers to board. Similarly, the metric can take into account the time needed to finish the ride, such as to drive to a parking location and park the vehicle, clean and check the vehicle, etc. The efficiency can also potentially take into account other maintenance related factors for the vehicle, such as a daily or weekly washing, interior cleaning, maintenance checks, and the like. The vehicle hours can also be compared against the number of riders, which can be prorated to the planned number of riders over a period of time for a specific service area. This comparison can provide a measure of fleet utilization, as the number of available seats for the vehicle hours can be compared against the number of riders to determine occupancy and other such metrics. These and other values can then be combined into an overall service efficiency metric, using weightings and functions for combining these factors, which can be used to score or rank various options provided using other metrics, such as the convenience or QoS metrics.

Certain metrics, such as optimal rider miles and optimal distance, can be problematic to use as a measure of efficiency in some situations. For example, relying on the planned or actual distance of trips as a quantization of the quality of service provided can potentially result in degradation in the rider experience. This can result from the fact that requiring the average rider to travel greater distances may result in better vehicle utilization, but can be less optimal for users that shorter trips. Optimization of distance metrics may then have the negative impact of offsetting any gains in service quality metrics. Accordingly, approaches in accordance with various embodiments can utilize a metric invariant of the behavior of the routing system. In some embodiments, the ideal mileage for a requested trip can be computed. This can assume driving a specific type of vehicle from the origin to the destination without any additional stops or deviations. The “optimal” route can then be determined based at least in part upon the predicted traffic or delays at the requested time of the trip for the ideal route. This can then be advantageously used as a measure of the service that is provided.

An example route determination system can consider trips that are already planned or being planned, as well as trips that are currently in progress. The system can also rely on routes and trips that occurred in the past, for purposes of determining the impact of various options. For trips that are in progress, information such as the remaining duration and distance can be utilized. Using information for planned routes enables the routing system to focus on a part of the service window that can still be impacted, typically going forward in time. For prorated and planned but not yet driven routes, the optimal distance may be difficult to assess directly since the route is not actually being driven. To approximate the optimal distance not yet driven, the routing system can prorate the total optimal distance in some embodiments to represent a portion of the planned distance not yet driven.

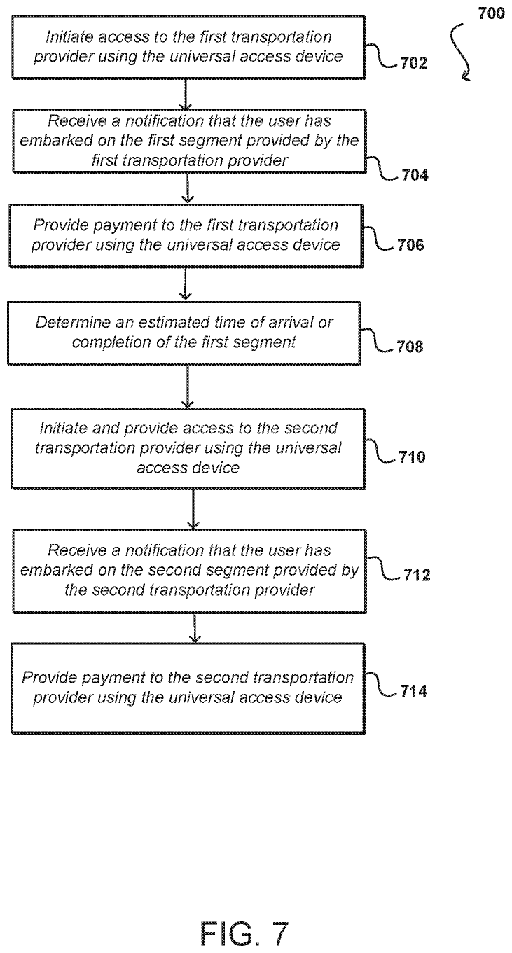

FIG.7 illustrates an example process 700 that can be used to provide access and payments to multiple segments in a route offering provided by multiple transportation providers and modes in accordance with various embodiments. As mentioned, various other route determination and optimization approaches can be used as well within the scope of the various embodiments to provide filter route offerings to a passenger requesting a ride. After the passenger has selected a particular multi-segment route, at 702, access to the first transportation provider may be initiated in the universal access device. The universal access device may be used to tag a kiosk to provide a notification that the user has embarked on the first segment that is provided by the first transportation provider, and this notification may be received 704 by a universal access system managing and providing the universal access cards. For example, if the first segment of the multi-segment trip is to take a train, the user may tag the universal access card or device at one or more kiosks distributed at the train station. This tag then notifies to the universal access system that the user has begun the first segment and is about to embark the scheduled train.

When the universal access system received a notification that the user has embarked, then the universal access device may provide payment to the first transportation provider 706, such that the user is only charged for the transportation that the user actually takes. In this example, once the user tags the universal access device at the train kiosk and boards the train, the universal access device is charged for the train segment of the route. In some embodiments, when the user embarks on the first segment of the trip, the entire payment amount of the full trip, including all segments, may be paid or initiated, and the subsequent segments may be deducted using the resources or funds withdrawn at the initiation of the first segment. The universal access system may determine an estimated time of arrival or completion of the first segment 708 to prepare for initiating access and payment for the second segment of the route. Using the universal access device, the user may access the second transportation provide to embark on the second segment of the trip 710. In this example, during a user's train ride for the first segment, the universal access system may load the universal access card with information to provide access to the second segment, which may be for a shared bicycle. The universal access card may be enabled to reserve a specific bicycle that is timed for when the user is to finish the train ride in the first segment and arrive at the shared bicycle pick-up location.

When the user arrives at the shared bicycle pick-up location and uses the universal access device to unlock the reserved bicycle, the universal access system may receive a notification that the user has embarked on the second segment provided by the second transportation provider 712. In another example, for a shared carpool ride, the driver picking up the user may initiate the notification to be sent to the universal access system. The notification may be initiated by the user or the transportation provider of that particular segment. Methods used to transmit the notification may include automatic transmission by tagging the universal access device at one or more kiosks, scanning a QR code displayed, entering a dynamic code displayed on the universal access device into a kiosk or interface for the transportation provider, manually checking in with an agent, checking in through a mobile application operating on a mobile computing device, and/or any other suitable method of communicating with the transportation provider of that transportation segment and mode that the user is embarking on that particular segment. When the user has embarked on that particular segment, then the universal access device may provide payment to the second transportation provider 714. In some embodiments, when the user embarks on the first segment of the trip, the entire payment amount of the full trip, including all segments, may be paid or initiated, and the subsequent segments may be deducted using the resources or funds withdrawn at the initiation of the first segment. As such, the second segment operated by the second transportation provider may receive payment through the first transportation provider, using the same payment option as the first transportation provider for the first segment, and/or with funds withdrawn when the user embarked on the first segment provided by the first transportation provider.

The universal access device may be a card with a chip, magnetic strip, or any other electronics that are enabled to communicate and transmit data over proximate distances to enable access and provide payment. In some embodiments, the universal access card may be enabled to operate in different modes, one mode for provide access and another mode for providing payment. The universal access device may also be a fob, key fob, or other device enabled to communicate with transportation providers. In another embodiment, the universal access device may be in communication with a user's computing device, such as a mobile phone, to be used in conjunction with a mobile application operating on the computing device with the interfaces displayed in FIGS. 6A-6D, for example.

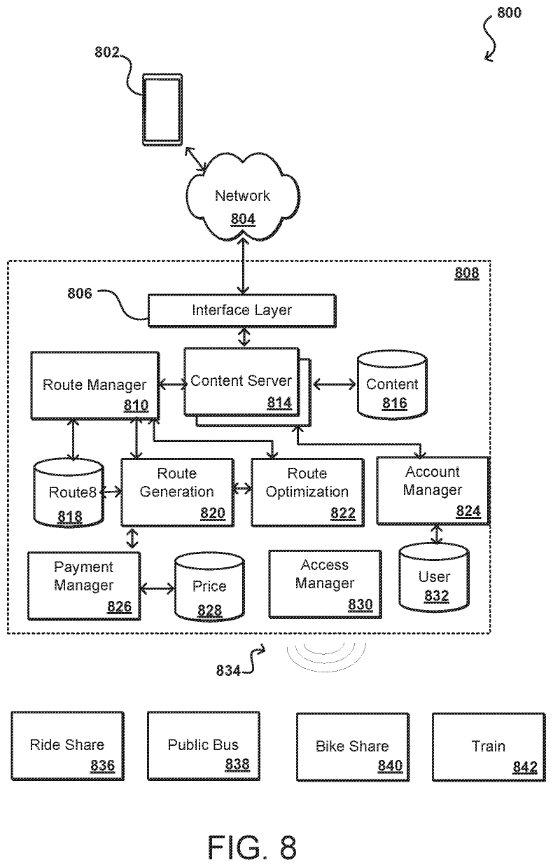

As mentioned, a route optimization system in some embodiments can attempt to utilize such an objective function in order to determine and compare various routing options. FIG. 8 illustrates an example system 800 that can be utilized to determine and manage vehicle routing in accordance with various embodiments. In this system, various users can use applications executing on various types of computing devices 802 to submit route requests over at least one network 804 to be received by an interface layer 806 of a service provider environment 808. The computing devices can be any appropriate devices known or used for submitting electronic requests, as may include desktop computers, notebook computers, smartphones, tablet computers, and wearable computers, among other such options. The network(s) can include any appropriate network for transmitting the request, as may include any selection or combination of public and private networks using wired or wireless connections, such as the Internet, a cellular data connection, a Wi-Fi connection, a local area network connection (LAN), and the like. The service provider environment can include any resources known or used for receiving and processing electronic requests, as may include various computer servers, data servers, and network infrastructure as discussed elsewhere herein. The interface layer can include interfaces (such as application programming interfaces), routers, load balancers, and other components useful for receiving and routing requests or other communications received to the service provider environment. The interfaces, and content to be displayed through those interfaces, can be provided using one or more content servers capable of serving content (such as web pages or map tiles) stored in a content repository 812 or other such location.

Information for the request can be directed to a route manager 814, such as may include code executing on one or more computing resources, configured to manage aspects of routes to be provided using various vehicles of a vehicle pool or fleet associated with the transport service. The route manager can analyze information for the request, determine available planned routes from a route data store 816 that have capacity can match the criteria of the request, and can provide one or more options back to the corresponding device 802 for selection by the potential rider. The appropriate routes to suggest can be based upon various factors, such as proximity to the origination and destination locations of the request, availability within a determined time window, and the like. In some embodiments, an application on a client device 802 may instead present the available options from which a user can select, and the request can instead involve obtaining a seat for a specific planned route at a particular planned time. As mentioned, in some embodiments the bookings or selections can be made by the route manager automatically based on various criteria, among other such options.

As mentioned, in some embodiments users can either suggest route information or provide information that corresponds to a route that would be desired by the user. This can include, for example, an origination location, a destination location, a desired pickup time, and a desired drop-off time. Other values can be provided as well, as may relate to a maximum duration or trip length, maximum number of stops, allowable deviations, and the like. In some embodiments at least some of these values may have maximum or minimum values, or allowable ranges, specified by one or more route criteria. There can also be various rules or policies in place that dictate how these values are allowed to change with various circumstances or situations, such as for specific types of users or locations. The route manager 814 can receive several such requests, and can attempt to determine the best selection of routes to satisfy the various requests. In this example the route manager can work with a route generation module 818 that can take the inputs from the various requests and provide a set of route options that can satisfy those requests. This can include options with different numbers of vehicles, different vehicle selections or placements, different modes of transportation, different segment options, and different options for getting the various customers to their approximate destinations at or near the desired times. It should be understood that in some embodiments customers may also request for specific locations and times where deviation is not permissible, and the route manager may need to either determine an acceptable routing option or deny that request if minimum criteria are not met. In some embodiments an option can be provided for each request, and a pricing manager 822 can determine the cost for a specific request using pricing data and guidelines from a price repository 824, which the user can then accept or reject.

In this example, the route generation module 818 can generate a set of routing options based on the received requests for a specified area over a specified period of time. A route optimization module 820 can perform an optimization process using the provided routing options to determine an appropriate set of routes to provide in response to the various requests. Such an optimization can be performed for each received request, in a dynamic routing system, or for a batch of requests, where users submit requests and then receive routing options at a later time. This may be useful for situations where the vehicle service attempts to have at least a minimum occupancy of vehicles or wants to provide the user with certainty regarding the route, which may require a quorum of riders for each specific planned route in some embodiments. In various embodiments an objective function is applied to each potential route in order to generate a route “quality” score, or other such value. The values of the various options can then be analyzed to determine the routing options to select. In one embodiment, the route optimization module 820 applies the objective function to determine the route quality scores and then can select the set of options that provides the highest overall, or highest average, total quality score. Various other approaches can be used as well as would be understood to one of ordinary skill in the art in light of the teachings and suggestions contained herein.

In at least some embodiments, the objective function can be implemented independent of a particular implementation of an optimization algorithm. Such an approach can enable the function to be used as a comparative metric of different approaches based on specific inputs. Further, such an approach enables various optimization algorithms to be utilized that can apply different optimization approaches to the various routing options to attempt to develop additional routing options and potential solutions, which can help to not only improve efficiency but can also potentially provide additional insight into the various options and their impact or interrelations. In some embodiments an optimization console can be utilized that displays the results of various optimization algorithms, and enables a user to compare the various results and factors in an attempt to determine the solution to implement, which may not necessarily provide the best overall score. For example, there might be minimum values or maximum values of various factors that are acceptable, or a provider might set specific values or targets on various factors, and look at the impact on the overall value and select options based on the outcome. In some embodiments the user can view the results of the objective function as well, before any optimization is applied, in order to view the impact of various factor changes on the overall score. Such an approach also enables a user or provider to test new optimization algorithms before selecting or implementing them, in order to determine the predicted performance and flexibility with respect to existing algorithms.

Further, such an approach enables algorithms to evolve automatically over time, as may be done using random experimentation or based on various heuristics. As these algorithms evolve, the value of the objective function can serve as a measure of fitness or value of a new generation of algorithms. Algorithms can change over time as the service areas and ridership demands change, as well as to improve given the same or similar conditions. Such an approach may also be used to anticipate future changes and their impact on the service, as well as how the various factors will change. This can help to determine the need to add more vehicles, reposition parking locations, etc.

In some embodiments artificial intelligence-inclusive approaches, such as those that utilize machine learning, can be used with the optimization algorithms to further improve the performance over time. For example, the raising and lowering of various factors may result in a change in ridership levels, customer reviews, and the like, as well as actual costs and timing, for example, which can be fed back into a machine learning algorithm to learn the appropriate weightings, values, ranges, or factors to be used with an optimization function. In some embodiments the optimization function itself may be produced by a machine learning process that takes into account the various factors and historical information to generate an appropriate function and evolve that function over time based upon more recent result and feedback data, as the machine learning model is further trained and able to develop and recognize new relationships.

Various pricing methods can be used in accordance with the various embodiments, and in at least some embodiments the pricing can be used as a metric for the optimization. For example, the cost factors in some embodiments can be evaluated in combination with one or more revenue or profitability factors. For example, a first ride option might have a higher cost than a second ride option, but might also be able to recognize higher revenue and generate higher satisfaction. Certain routes for dedicated users with few to no intermediate stops might have a relatively high cost per rider, but those riders might be willing to pay a premium for the service. Similarly, the rider experience values generated may be higher as a result. Thus, the fact that this ride option has a higher cost should not necessarily have it determined to be a lower value option than others with lower cost but also lower revenue. In some embodiments there can be pricing parameters and options that are factored into the objective function and optimization algorithms as well. Various pricing algorithms may exist that determine how much a route option would need to have charged to the individual riders. The pricing can be balanced with consumer satisfaction and willingness to pay those rates, among other such factors. The pricing can also take into various other factors as well, such as tokens, credits, discounts, monthly ride passes, and the like. In some embodiments there might also be different types of riders, such as customer who pay a base rate and customers who pay a premium for a higher level of service. These various factors can be considered in the evaluation and optimization of the various route options.

Various other such functions can be used as well within the scope of the various embodiments as would be apparent to one of ordinary skill in the art in light of the teachings and suggestions contained herein.

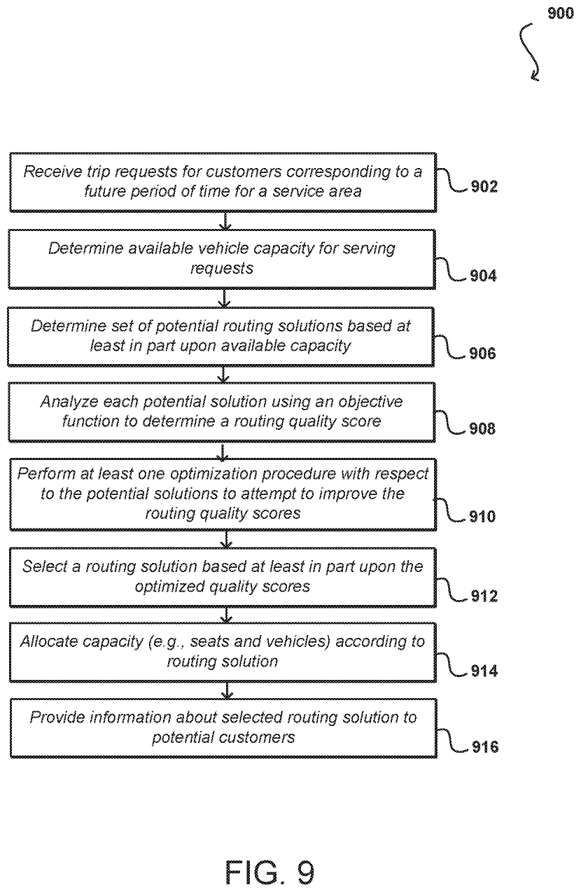

For any of the segments or full journeys, requests can be received for a number of potential riders and the best set of options can be determined that satisfies the customer requests but also satisfies various business requirements as discussed herein. FIG. 9 illustrates an example process 900 that can be used to determine various routing options to serve a set of rider requests in accordance with various embodiments. As mentioned, various other route determination and optimization approaches can be used as well within the scope of the various embodiments. In this example, a number or journey or trip requests are received 902 from, or on behalf of, various potential customers of a transportation service. The requests in this example relate to a future period of time, for at least one specified service area or region, in which the transport is to occur for one or more persons, animals, packages, or other objects or passengers. The requests can be submitted through an application executed on a computing device in many embodiments, although other request mechanisms can be used as well. In order to determine how to best serve the requests, this example process first determines 904 available vehicle capacity for serving the requests. This can include, for example, determining which vehicles or transport mechanisms are available to that service area over the specified future period of time, as well as the available seating or other capacity of those vehicles for that period of time. As mentioned, in some embodiments at least some of the seats of the various vehicles may already be committed or allocated to specific routes, riders, packages, or other such options.

Based at least in part upon the various available vehicles and capacity, a set of potential routing solutions can be determined 906. This can include, for example, using one or more route determination algorithms that are configured to analyze the various origination and destination locations, as well as the number of passengers and corresponding time windows for each, and generate a set of routing solutions for serving the various requests. The potential solutions can attempt to allocate vehicles to customers based on, for example, common or proximate origination and destination locations, or locations that can be served by a single route of a specific vehicle. In some embodiments a routing algorithm can potentially analyze all possible combinations for serving the requests with the available vehicles and capacity, and can provide any or all options that meet specific criteria, such as at least a minimum utilization or profitability, or at most a maximum allowable deviation (on average or otherwise) from the parameters of the various customer requests. This can include, for example, values such as a distance between the requested origination location and a suggested pick up point, deviations from a requested time, and the like. In some embodiments all potential solutions can be provided for subsequent analysis.

In this example process, the various potential routing solutions can be analyzed 908 using an objective function that balances various factors, such as provider efficiency and customer satisfaction, or at least takes those factors into consideration as discussed elsewhere herein. Each potential routing solution that is analyzed using the function, or at least that meets specific minimum criteria, can be provided with a routing quality score generated inserting the relevant values for the solution into the objective function. This can include, for example determining a weighted combination of various quality factors as discussed herein. In some embodiments, the solution with the best (e.g., highest or lowest) quality score can be selected for implementation. In this example, however, at least one optimization procedure is performed 910 with respect to at least some of the potential solutions. In some embodiments the process might be performed for all potential solutions, while in others only a subset of the solutions will go through an optimization procedure, where solutions with a quality score outside an acceptable range may not be considered for optimization in order to conserve time and resources. The optimization process can attempt to improve the quality scores of the various solutions. As discussed herein, an optimization process can attempt to adjust various parameters of the solution, such as to adjust pickup times, stops per route, capacity distribution, and the like. As mentioned, multiple optimization procedures may be applied in some embodiments, where the algorithms may look at different factors or adjustable ranges, etc. Different optimization algorithms may also optimize for, or prioritize, different factors, such as different QoS or efficiency components, profitability, rider comfort, and the like.

After the optimization, at least some of the various proposed solutions may have updated quality scores. Some of the proposed solutions may also have been removed from consideration based on, for example, unacceptable quality scores or an inability to adequately serve a sufficient number of the pending requests, among other such factors. A specific routing solution can then be selected 912 from the remaining solutions, where the solution can be selected based at least in part upon the optimized quality scores. For example, if optimizing for factors such as profitability or customer satisfaction rating, it can be desirable to select the option with the highest score. If optimizing for factors such as cost, it might be desirable to select the option with the lowest score. Other options can be utilized as well, such as to select the score closest to a target number (e.g., zero). As mentioned, other factors may be considered as well. For example, a solution might be selected that has close to the best quality score, but has a much better profitability or customer satisfaction value, or satisfies one or more other such goals or criteria. Once the solution is determined, the appropriate capacity can be allocated 914 based upon vehicles and seating, among other potential options, determined to be available for the determined region at, or near, the future period of time. This can include, for example, determining routes and stops, and assigning vehicles with appropriate capacity to specific routes. The assignment of specific types of vehicles for certain routes may also be specified in the routing options, as there may be certain types of vehicles that get better gas mileage in town and some that get better gas mileage on the highway, for example, such that operational costs can be broken down by types of vehicles as well. In some embodiments specific vehicles might also be due to service for a specific mileage target, which can be factored in as well as other factors, such as cost per mile, type of gasoline, fuel, or power utilized, and the like. Information about the selected routing option can then be provided 916 to particular customers, such as those associated with the received requests. The information can indicate to the users various aspects such as the time and location of pickup, the route being taken, the location and approximate time of arrival at the destination, and potentially information about the specific vehicle and driver, among other such options.

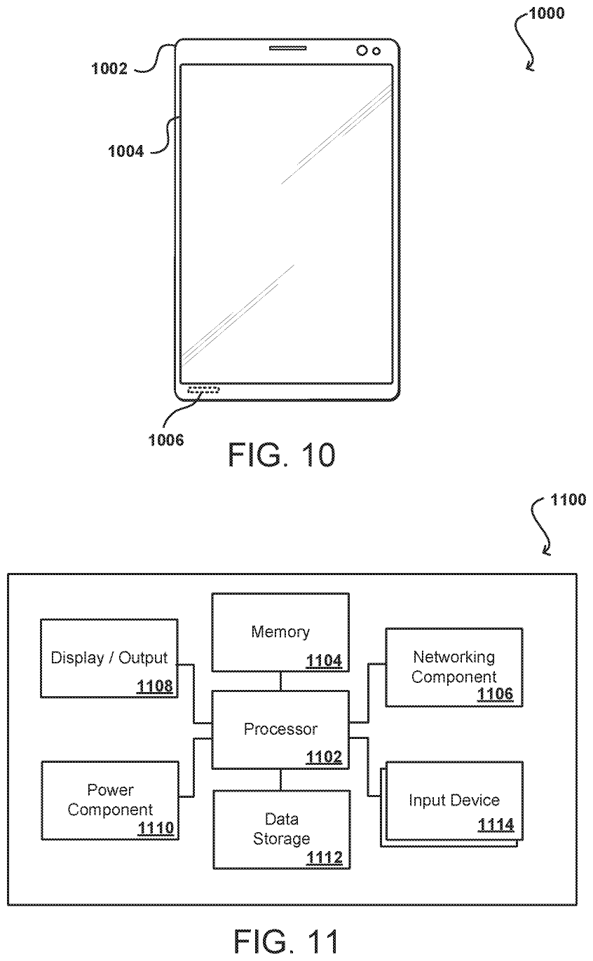

FIG. 10 illustrates an example computing device 1000 that can be used in accordance with various embodiments. Although a portable computing device (e.g., a smart phone or tablet computer) is shown, it should be understood that any device capable of receiving, processing, and/or conveying electronic data can be used in accordance with various embodiments discussed herein. The devices can include, for example, desktop computers, notebook computers, smart devices, Internet of things (IoT) devices, video gaming consoles or controllers, wearable computers (e.g., smart watches, glasses, or contacts), television set top boxes, and portable media players, among others. In this example, the computing device 1000 has an outer casing 1002 covering the various internal components, and a display screen 1004 such as a touch screen capable of receiving user input during operation of the device. These can be additional display or output components as well, and not all computing devices will include display screens as known in the art. The device can include one or more networking or communication components 1006, such as may include at least one communications subsystem for supporting technologies such as cellular communications, Wi-Fi communications, BLUETOOTH® communications, and so on. There may also be wired ports or connections for connecting via a land line or other physical networking or communications component.

FIG. 11 illustrates an example set of components 1100 that can comprise a computing device 1000 such as the device described with respect to FIG. 10, as well as computing devices for other purposes such as application servers and data servers. A universal access card or device according to various embodiments may also have some or all of the components in 1100. For example, a universal access and payment card may have a data storage 1112 component and a networking component 1106 to enable communications with a kiosk, a user's computing device (e.g., mobile phone), point-of-sale device, or other computing device. The networking component 1106 in the universal access card may be configured for near-field communication (NFC), BLUETOOTH®, or other proximate communication or transmission protocol. The illustrated example device includes at least one main processor 1102 for executing instructions stored in physical memory 1104 on the device, such as dynamic random-access memory (DRAM) or flash memory, among other such options. As would be apparent to one of ordinary skill in the art, the device can include many types of memory, data storage, or computer-readable media as well, such as a hard drive or solid state memory functioning as data storage 1106 for the device. Application instructions for execution by the at least one processor 1102 can be stored by the data storage 1106 then loaded into memory 1104 as needed for operation of the device 1100. The processor can also have internal memory in some embodiments for temporarily storing data and instructions for processing. The device can also support removable memory useful for sharing information with other devices. The device will also include one or more power components 1110 for powering the device. The power components can include, for example, a battery compartment for powering the device using a rechargeable battery, an internal power supply, or a port for receiving external power, among other such options.

The computing device may include, or be in communication with, at least one type of display element 1108, such as a touch screen, organic light emitting diode (OLED), or liquid crystal display (LCD). Some devices may include multiple display elements, as may also include LEDs, projectors, and the like. The device can include at least one communication or networking component 1112, as may enable transmission and receipt of various types of data or other electronic communications. The communications may occur over any appropriate type of network, such as the Internet, an intranet, a local area network (LAN), a 5G or other cellular network, or a Wi-Fi network, or can utilize transmission protocols such as BLUETOOTH® or NFC, among others. The device can include at least one additional input device 1114 capable of receiving input from a user or other source. This input device can include, for example, a button, dial, slider, touch pad, wheel, joystick, keyboard, mouse, trackball, camera, microphone, keypad, or other such device or component. Various devices can also be connected by wireless or other such links as well in some embodiments. In some embodiments, a device might be controlled through a combination of visual and audio commands, or gestures, such that a user can control the device without having to be in contact with the device or a physical input mechanism.

Much of the functionality utilized with various embodiments will be operated in a computing environment that may be operated by, or on behalf of, a service provider or entity, such as a rideshare provider or other such enterprise. There may be dedicated computing resources, or resources allocated as part of a multi-tenant or cloud environment. The resources can utilize any of a number of operating systems and applications, and can include a number of workstations or servers Various embodiments utilize at least one conventional network for supporting communications using any of a variety of commercially-available protocols, such as TCP/IP or FTP, among others. As mentioned, example networks include for example, a local area network, a wide-area network, a virtual private network, the Internet, an intranet, and various combinations thereof. The servers used to host an offering such as a ridesharing service can be configured to execute programs or scripts in response requests from user devices, such as by executing one or more applications that may be implemented as one or more scripts or programs written in any programming language. The server(s) may also include one or more database servers for serving data requests and performing other such operations. The environment can also include any of a variety of data stores and other memory and storage media as discussed above. Where a system includes computerized devices, each such device can include hardware elements that may be electrically coupled via a bus or other such mechanism. Example elements include, as discussed previously, at least one central processing unit (CPU), and one or more storage devices, such as disk drives, optical storage devices and solid-state storage devices such as random access memory (RAM) or read-only memory (ROM), as well as removable media devices, memory cards, flash cards, etc. Such devices can also include or utilize one or more computer-readable storage media for storing instructions executable by at least one processor of the devices. An example device may also include a number of software applications, modules, services, or other elements located in memory, including an operating system and various application programs. It should be appreciated that alternate embodiments may have numerous variations from that described above.

Various types of non-transitory computer-readable storage media can be used for various purposes as discussed and suggested herein. This includes, for example, storing instructions or code that can be executed by at least one processor for causing the system to perform various operations. The media can correspond to any of various types of media, including volatile and non-volatile memory that may be removable in some implementations. The media can store various computer readable instructions, data structures, program modules, and other data or content. Types of media include, for example, RAM, DRAM, ROM, EEPROM, flash memory, solid state memory, and other memory technology. Other types of storage media can be used as well, as may include optical (e.g., Blu-ray or digital versatile disk (DVD)) storage or magnetic storage (e.g., hard drives or magnetic tape), among other such options. Based on the disclosure and teachings provided herein, a person of ordinary skill in the art will appreciate other ways and/or methods to implement the various embodiments.

The specification and drawings are to be regarded in an illustrative sense, rather than a restrictive sense. It will, however, be evident that various modifications and changes may be made thereunto without departing from the broader spirit and scope of the various embodiments as set forth in the claims.

What is claimed is:

1. A computer-implemented method comprising:
receiving a transportation request from a customer to travel from a first location to a second location;
determining a first multi-segment route between the first location and the second location, the first multi-segment route comprising a first segment that is served by a first transportation provider and a second segment that is served by a second transportation provider;
offering to the customer, a first option to select the first multi-segment route;
determining that the customer has selected the first option; and
automatically utilizing a universal access card to pay the first transportation provider when the customer utilizes a first vehicle of the first transportation provider to travel the first segment, and to pay the second transportation provider when the customer utilizes a second vehicle of the second transportation provider to travel the second segment.

2. The computer-implemented method of claim 1, wherein the universal access card is a multi-functional card that provides a payment mode of use and an access mode of use, the payment mode of use useable by the customer to make payments, and the access mode of use useable by the customer to enter the first vehicle for traveling the first segment and to enter the second vehicle for traveling the second segment.

3. The computer-implemented method of claim 2, wherein the universal access card is provided in a smartphone of the customer.

4. The computer-implemented method of claim 1, further comprising:
automatically making a first reservation for travel in a first vehicle and a second reservation for travel in a second vehicle, upon determining that the customer has selected the first option.

5. The computer-implemented method of claim 4, wherein at least one of the first vehicle or the second vehicle is a rideshare vehicle, and wherein automatically making the first reservation and the second reservation comprises determining a suitability of the rideshare vehicle for use by the customer.

6. The computer-implemented method of claim 1, further comprising:
determining a second multi-segment route between the first location and the second location;
offering to the customer, the first option to select the first multi-segment route and a second option to select the second multi-segment route;
determining that the customer has selected the second option; and
automatically utilizing the universal access card to pay one or more transportation providers when the customer utilizes one or more vehicles of the one or more transportation providers to travel the second multi-segment route.

7. The computer-implemented method of claim 6, wherein the one or more transportation providers includes at least one of the first transportation provider or the second transportation provider.

8. A computer-implemented method comprising:
receiving a transportation request from a customer to travel from a first location to a second location;
determining a first multi-segment route between the first location and the second location, the first multi-segment route comprising a first segment that is served by a first transportation provider and a second segment that is served by a second transportation provider;
automatically utilizing a universal access card to pay the first transportation provider when the customer utilizes a first vehicle of the first transportation provider to travel the first segment of the first multi-segment route;
automatically utilizing the universal access card to pay the second transportation provider when the customer utilizes a second vehicle of the second transportation provider to travel the second segment of the first multi-segment route; and
allowing use of the universal access card by the customer to enter at least one of the first vehicle or the second vehicle.

9. The computer-implemented method of claim 8, further comprising:
determining a second multi-segment route between the first location and the second location;
offering to the customer, a first option to select the first multi-segment route and a second option to select the second multi-segment route;
determining that the customer has selected the second option; and
automatically utilizing the universal access card to pay one or more transportation providers when the customer utilizes one or more vehicles of the one or more transportation providers to travel the second multi-segment route.

10. The computer-implemented method of claim 9, further comprising:
automatically making a first reservation for travel in the first vehicle and a second reservation for travel in the second vehicle, upon determining that the customer has selected the first option.

11. The computer-implemented method of claim 10, wherein at least one of the first vehicle or the second vehicle is a rideshare vehicle, and wherein automatically making the first reservation and the second reservation comprises determining a suitability of the rideshare vehicle for use by the customer.

12. The computer-implemented method of claim 9, wherein the universal access card is provided in a smartphone of the customer.

13. The computer-implemented method of claim 12, wherein offering to the customer, the first option to select the first multi-segment route comprises displaying on the smartphone, identification information about the first vehicle and the second vehicle, and timing information pertaining to the first segment and the second segment.

14. The computer-implemented method of claim 8, wherein allowing use of the universal access card by the customer to enter the at least one of the first vehicle or the second vehicle comprises the universal access card being switched from a payment mode of use to an access mode of use.

15. The computer-implemented method of claim 14, wherein the universal access card is configured to automatically switch from the payment mode of use to the access mode of use when the universal access card is used by the customer to enter the at least one of the first vehicle or the second vehicle.

16. A system comprising:
a computer having a memory that stores computer-executable instructions and a processor configured to access the memory and execute the computer-executable instructions to at least:
receive a transportation request from a customer to travel from a first location to a second location;
determine a first multi-segment route between the first location and the second location, the first multi-segment route comprising a first segment that is served by a first transportation provider and a second segment that is served by a second transportation provider;
offer to the customer, a first option to select the first multi-segment route;
determine that the customer has selected the first option; and
automatically utilize a universal access card to pay the first transportation provider when the customer utilizes a first vehicle of the first transportation provider to travel the first segment, and to pay the second transportation provider when the customer utilizes a second vehicle of the second transportation provider to travel the second segment.

17. The system of claim 16, wherein the universal access card is a multi-functional card that provides a payment mode of use and an access mode of use, the payment mode of use useable by the customer to make payments, and the access mode of use useable by the customer to enter the first vehicle for traveling the first segment and to enter the second vehicle for traveling the second segment.

18. The system of claim 17, wherein the universal access card is provided in a smartphone of the customer.

19. The system of claim 16, wherein the processor is further configured to access the memory and execute the computer-executable instructions to at least:
automatically make a first reservation for travel in a first vehicle and a second reservation for travel in a second vehicle, upon determining that the customer has selected the first option.

20. The system of claim 19, wherein at least one of the first vehicle or the second vehicle is a rideshare vehicle, and wherein automatically making the first reservation and the second reservation comprises determining a suitability of the rideshare vehicle for use by the customer.
